(19) United States
(12) Patent Application Publication
(10) Pub. No.: US 2010/0139807 A1
(43) Pub. Date: Jun. 10, 2010

(54) SUMP FOR FUEL DISPENSER

(76) Inventors: John Alexandre Boudry, Suffolk (GB); Lee Markham, Suffolk (GB)

Correspondence Address: HAYES SOLOWAY P.C., 3450 E. SUNRISE DRIVE, SUITE 140, TUCSON, AZ, 85718, US

(21) Appl. No.: 12/598,030

(22) PCT Filed: May 9, 2008
(86) PCT No.: PCT/GB08/01605

§ 371 Date: Oct. 28, 2009

(30) Foreign Application Priority Data
May 9, 2007 (GB) 0708850.3

(51) Int. Cl. B67D 7/32

(52) U.S. Cl. 141/86; 137/363

(57) ABSTRACT

A sump assembly (70) comprising: (i) a sump body (71) including a bottom and at least one side wall (72), the bottom and side wall(s) co-operating to define an open topped internal cavity within the sump body capable of containing fluids, the side walls further defining an opening (76) in the top of said sump; (ii) at least one flange (77) extending outwardly from the side wall(s), the flange incorporating fixing means (79) adapted, in use, to tie the sump into the surrounding structure; (iii) a mounting frame assembly (90) adapted, in use, to be keyed into the surrounding structure and to secure a dispensing unit in place; wherein the sump body and the flange(s) are of unitary construction, the flange(s) being formed as an integral part of the sump body.

### FIELD OF THE INVENTION

The present invention relates to sumps. It is particularly applicable, but in no way limited to sumps for use beneath fuel dispensing pumps. Such sumps are generally located below ground level and are designed to keep ground water out and to prevent any fuel drippage or leakage from entering the environment.

### BACKGROUND TO THE INVENTION

In a typical automotive fuelling station, fuel is delivered to an above-ground dispensing pump through a network of underground tanks, pipes, fittings, sumps and dispensers. The sumps used in these networks include sumps located beneath the above-ground dispensing units. These sumps preferably fit fully beneath the housings for the above-ground dispensing units and function to prevent ground contamination from any drippage of components in the above-ground dispensing units.

In order to reduce the risk of soil contamination, it is desirable, if not imperative, for sumps located beneath the above-ground dispensing units to receive any and all fuel that may leak or drip from the dispensing units. For this reason, the openings of such sumps are large enough to completely cover the potential drip area beneath the dispensing units. It also is economically desirable to avoid making the sumps too large.

Thus, it is common to have properly designed sumps with openings that are sized and shaped to match the footprint of the dispensing unit housing, ie the size and shape of the opening of the sump are sized and shaped to correspond to the area where drippage may occur.

In a typical installation the sumps are made from a plastics material such as a polymer eg polyethylene or polypropylene, or from a resin such as glass or fibre reinforced plastic (GRP/FRP). The dispensing unit is connected to the sump by way of a mounting frame which itself is bolted to the sump. This inevitably involves drilling or forming holes in the side walls of the sump. These perforations in the body of the sump have to be sealed to avoid ingress of ground water and any egress of fuel or fuel vapour into the surrounding ground. In practice sealing these penetrations, and retaining those seals over many years proves difficult and requires regular checks and maintenance as necessary.

A further problem with current sumps is the fact that they are inevitably provided with opposing channels to accommodate unistruts, which in turn support stabiliser bars designed to hold the fuel supply pipes and associated safety connectors. These channels extend inwardly across the top opening of the sump and partially block access to the sump contents.

As explained above, containment sumps are known. An example of a prior art sump is illustrated in U.S. Pat. No. 5,800,143 (Bravo). This illustrates an arrangement where an anchor frame is attached to the top of a sump, with a dispenser frame being attached to the anchor frame. This results in numerous penetrations through the upper region of the sump, with all the disadvantages of potential water ingress/fuel egress described above. It also clearly serves to illustrate how fixing rails (27) restrict the sump opening.

U.S. Pat. No. 5,099,894 (Mozeley) describes a fibreglass sump with an outwardly extending flange but, as with other prior art, fixings which penetrate through the sump walls are required to connect the dispenser to the sump, in this case through an intermediate shear box. This arrangement has all the disadvantages outlined above.

WO99/16978 (Mangum) describes a two-part sump having a lower, rectangular portion and a separate tapered upper portion. The two portions are sealed together on site during construction. Once again, the unistrut rails encroach on the sump opening and there are penetrations through the sump body below ground level.

U.S. Pat. No. 5,257,652 (Total Containment Inc) describes a sump with a riser where a separate flanged portion is bolted through the sump riser near its top. The bolt holes provide a route for water ingress/fuel egress.

A further typical prior art sump with a so-called unitary sump frame is illustrated in U.S. Pat. No. 5,813,797 (Pendleton & Matracia). Once again, this has all the disadvantages outlined above.

It is an object of the present invention to overcome or at least mitigate one or more of these problems.

### SUMMARY OF THE INVENTION

According to a first aspect of the present invention there is provided a sump assembly according to claim 1. Preferably said sump assembly comprises:—
(i) a sump body including a bottom and at least one side wall, the bottom and side wall(s) co-operating to define an open topped internal cavity within the sump body capable of containing fluids, the side walls further defining an opening in the top of said sump;
(ii) at least one flange extending outwardly from the side wall(s), the flange incorporating fixing means adapted, in use, to tie the sump into the surrounding structure;
(iii) a mounting frame assembly adapted to be keyed into the surrounding structure and to secure a dispensing unit in place, wherein the sump body and flange(s) are of integral construction.

By providing a flange integral with the sump side wall(s) it is no longer necessary to perforate the sump to attach a separate frame or flange. Thus the sump body remains imperforated.

Preferably the sump body incorporates a retaining rib at or near the opening, said rib being adapted to retain the mounting frame assembly without the need to form penetrations in the side wall(s).

The retaining rib is just one form of mounting frame retaining means which could be used to retain the mounting frame assembly in place during construction.

Preferably the sump body further comprises a channel, said channel being adapted to accommodate a strut mounting assembly such that said strut mounting assembly does not extend substantially into the opening in the top of the sump body and thus does not restrict access to the sump body.

By providing the sump assembly with an integral flange, this provides a location for this channel, away from sump opening, but directly adjacent to that opening, giving unrestricted access to the sump opening when the unistruct mounting channel is in place.

Preferably the flange fixing means comprises apertures or eyelets in the flange designed to be embedded in concrete. These are inexpensive to manufacture and effective in use.

Preferably the mounting frame assembly comprises a mounting plate, and preferably said mounting plate incorporates dependent lugs adapted to tie the plate into the surrounding concrete.

Preferably said mounting plate incorporates conduit entry holes. These entry holes allow cables and other items safe and effective entry into the sump body and thus dispensing units.

Preferably said mounting frame assembly further comprises a mounting frame adapted to secure a dispensing unit to the sump assembly.

Preferably said mounting frame incorporates apertures for anchor bolts to anchor a dispenser unit to the sump assembly.

### BRIEF DESCRIPTION OF THE DRAWINGS

The present invention will now be described by way of example only with reference to the accompanying drawings, wherein:—

FIGS. 1A, 1B and 1C illustrate perspective, end and side elevations of a prior art sump assembly showing a prior art mounting frame with J-bolts;

FIG. 2 shows a perspective view of a sump body according to a first embodiment to the present invention;

FIG. 3 shows a perspective view in exploded format of a sump assembly according to a first embodiment;

FIG. 4 illustrates a cross-section of the assembled sump assembly shown in FIG. 3;

FIG. 5 illustrates side, end and a detail view of a sump body according to a first aspect of the present invention;

FIG. 6 shows a perspective view of a sump body according to a second embodiment;

FIG. 7 shows a perspective view of an exploded format of a sump assembly according to a second embodiment;

FIG. 8 illustrates a side view of an assembled sump assembly shown in FIG. 7;

FIG. 9 illustrates a cross-section along line A-A in FIG. 8;

FIGS. 10, 11 and 12 illustrate two perspective views and a cross-sectional view of a third embodiment, showing J-bolts in place in the mounting frame ready to accept a dispensing unit.

FIG. 13 is a schematic representation of a prior art fluid dispensing network for a typical fuel dispensing station depicting various components of the network for dispening fuel from an underground storage tank to an above-ground dispenser.

### DESCRIPTION OF THE PREFERRED EMBODIMENTS

The present embodiments represent currently the best ways known to the applicant of putting the invention into practice. But they are not the only ways in which this can be achieved. They are illustrated, and they will now be described, by way of example only. By way of terminology used in this document the following definitions apply:—

Sump/Containment chamber—any receptacle designed to keep a fluid in or out. This includes, but is not limited to, access manhole and sump chambers as described herein. It also includes tanks in general.
Flange—any collar or extension suitable for providing anchorage of a sump assembly into the surrounding ground, usually into concrete. The flange may be augmented by J-bolts or other fixings. Where the flange is described as an “integral” flange, this is intended to encompass arrangements where the flange is formed with the sump during the sump construction process, for example by injection or rotomoulding. It is also intended to encompass arrangements where the sump and flange are initially formed separately and joined together to form a unitary construction during manufacture.
Fluid—whilst the examples provided relate mainly to liquids, the term fluid refers to liquids, vapours and gases. For example, should a leak occur in a secondarily contained pipe in a garage forecourt installation then petrol or petrol vapour will collect in the manhole chamber. It is essential that this petrol vapour cannot escape through the wall of the chamber and into the surrounding ground.
Pipe—where pipes are referred to herein they are generally of circular cross-section. However, the term also covers other cross-sections such as box sections, corrugated and the like and secondarily contained pipes of the “pipe-within-a-pipe” type.
Glass reinforced plastic (GRP)—The term GRP has a very broad meaning in this context. It is intended to encompass any fibre-reinforced plastic wherein a fibre of any type is used to strengthen a thermosetting resin or other plastics material.
Plastics Material—The term has a very broad meaning in this context and is intended to encompass any polymeric material including thermoplastics, thermosets, elastomeric or any other polymeric material.

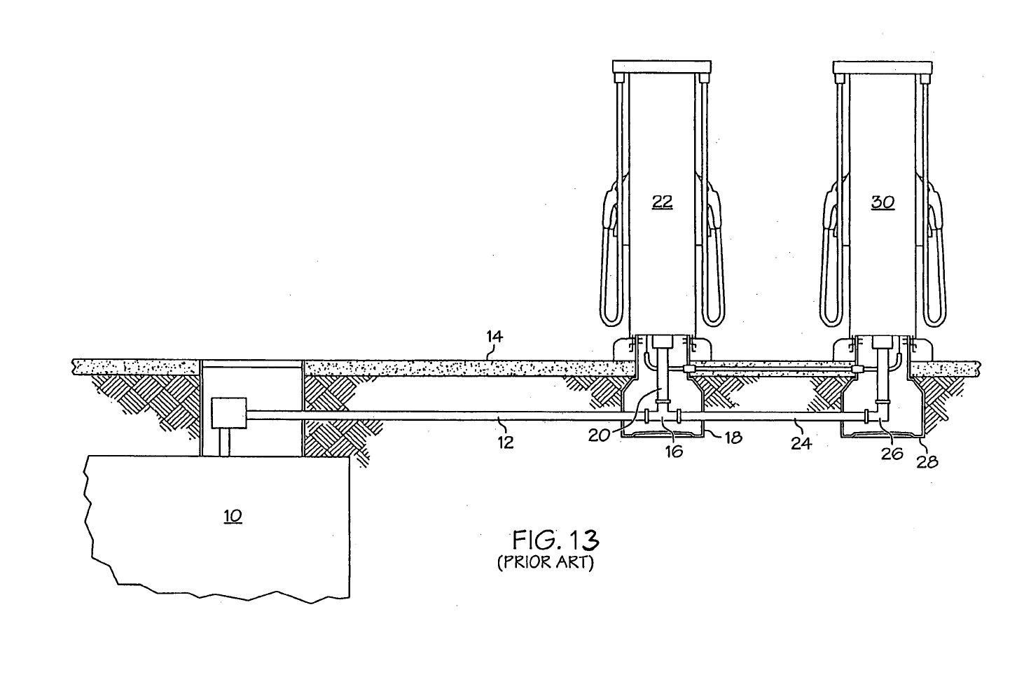

Referring now to the drawings, and to FIG. 13 in particular, a prior art networking of fluid dispensing components of the type typically found in a fuel dispensing station is shown. The network includes an underground storage tank 10 from which gasoline or other fuel is pumped and delivered to a fuel delivery pipe 12. As depicted in FIG. 13, the fuel delivery pipe 12 is disposed in an underground position beneath a drive surface 14 of the dispensing station. The fuel delivery pipe 12 terminates in a T-fitting 16 disposed within an underground sump assembly 18. The T-fitting 16 directs the flow of fuel from the underground storage tank 10 to a riser pipe 20 beneath an above-ground dispensing unit 22, and to a further delivery pipe 24. The delivery pipe 24 directs fuel to a fitting 26 disposed within a sump assembly 28 beneath a further above-ground dispensing unit 30.

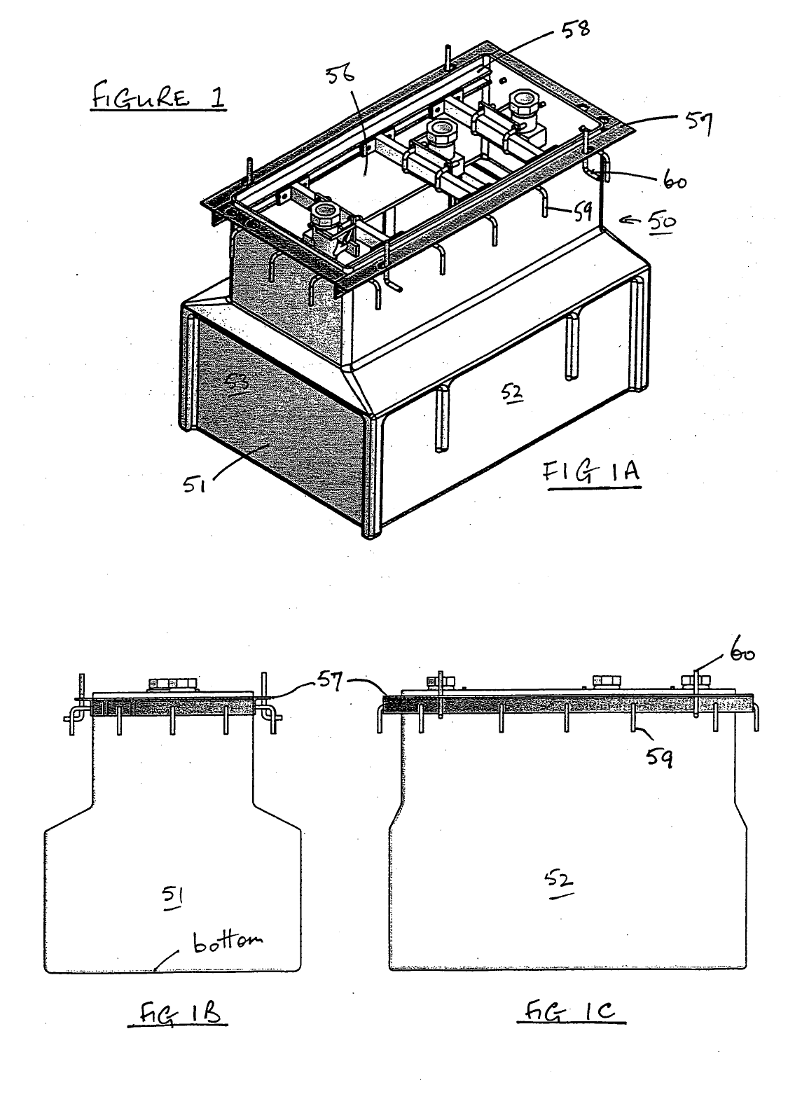

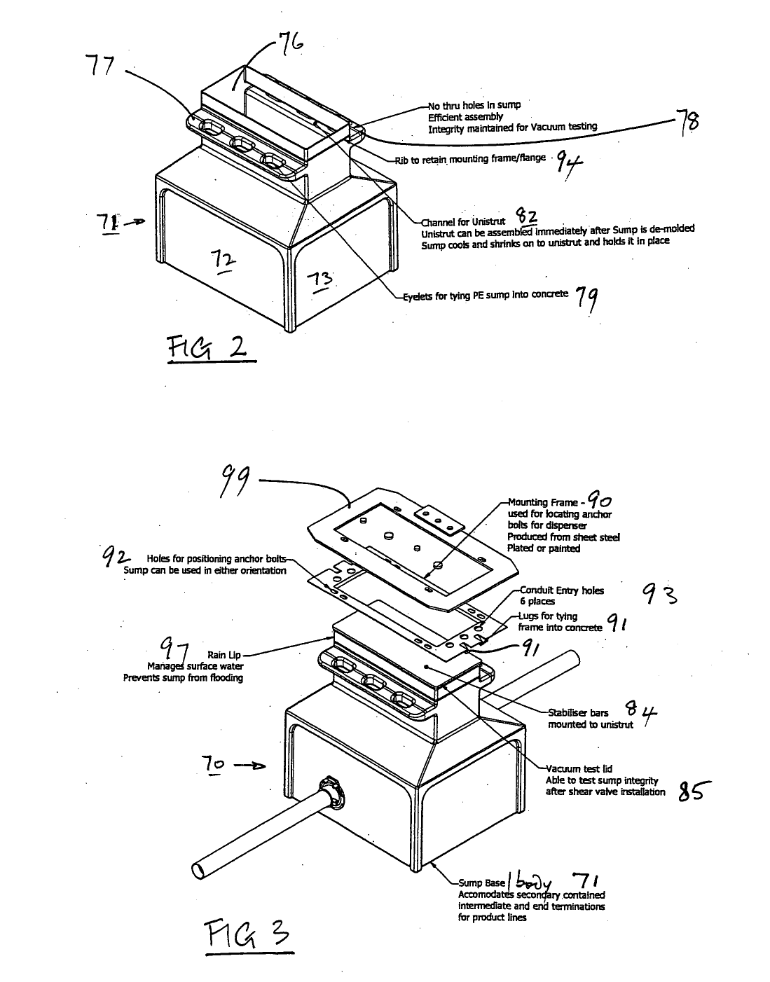

A typical prior art sump assembly 50 is shown in more detail in FIGS. 1A to 1C. These figures illustrate a sump body 51 made up of a bottom and four side walls 52,53,54 and 55 which together define an opening 56 in the top of the sump. Around that opening is located a specially designed and constructed frame 57 which is designed to serve two purposes. The frame 57 is bolted securely to the outside perimeter of the sump opening and serves both to secure the sump assembly into the surrounding ground and also to act as a mounting frame onto which to mount a fuel dispensing unit or station. It will be seen that so-called J-bolts are used to secure the frame to the outside of the sump and these bolts pass through apertures which are drilled or otherwise formed in the side of the sump. As explained above, it is essential that these apertures are sealed around the bolts and sealed completely. This is to avoid the ingress of any water from the surrounding ground into the sump and to prevent any egress of liquid within the sump into the surrounding environment. The J-bolts 59 are also used to secure a channel to the inside face of the sump along each of the longest sides of the sump opening. These channels serve to support unistruts which are used to secure the fuel delivery pipes and their associated safety fittings within the sump assembly. Further J-bolts 60 serve as mounting points to mount onto the sump a fuel dispensing unit (not shown). The disadvantages of such an arrangement have been explained above.

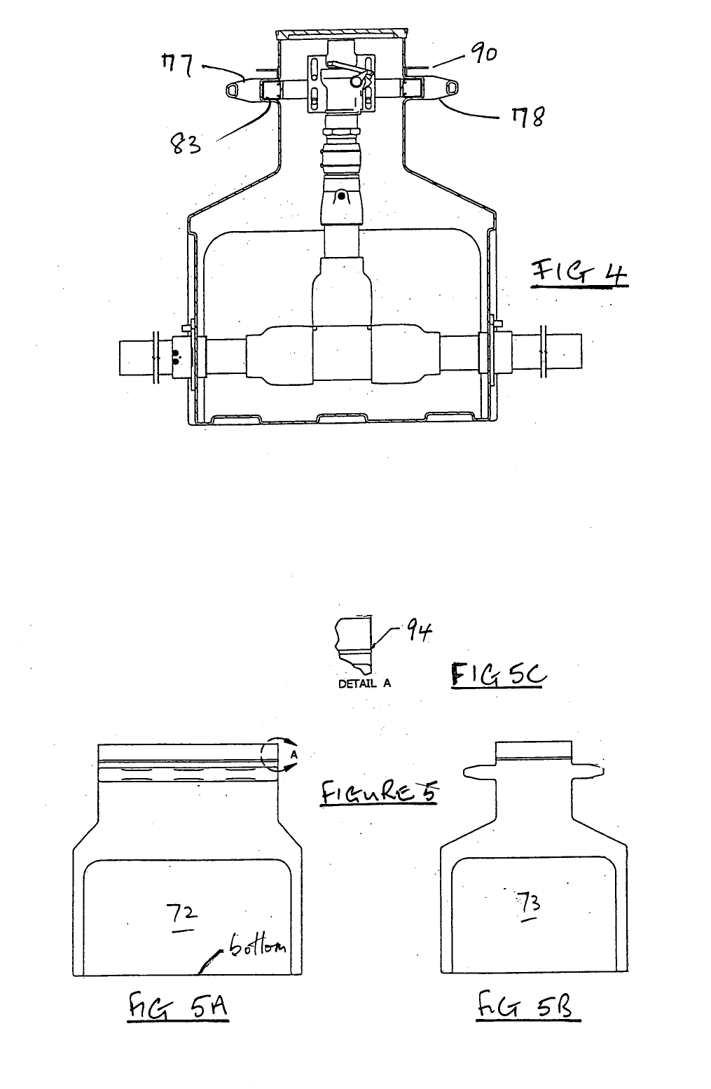

Turning now to FIGS. 2 to 5 inclusive, these illustrate a first embodiment of the present invention. These illustrate a sump assembly 70 including a sump body 71 formed from a sump bottom (not shown) and sump side walls a 72,73,74 and 75. In the perspective views shown only side walls 72 and 73 are visible. Two flanges 77,78 integral with the sump side walls extend from each long side of the sump body near to the opening 76 in the top of the sump. These flanges replace one function of the frame 57 in the prior art sump assembly in that they provide anchorage of the sump body into the surrounding ground which is generally formed from concrete made up to ground level. These flanges incorporate anchorage means in the form of apertures or eyelets which enable the sump to be tied into the concrete. These apertures or eyelets 79 extend through the body of the flange such that, during installation, concrete can flow above, below and through the body of the flange in order that it is embedded firmly in the concrete structure surrounding the sump body. Whilst providing apertures in the flanges is a cost-effective method of providing fixing or anchorage means, this is not the only way that this can be achieved. Other shapes or protrusions can be moulded into the flanges, including metal or other extensions. However, an essential feature is that the fixing means do not require or cause any penetration or perforation of the sump body. Nor does the attachment of the flanges to the sump body require any penetration or perforation of the sump side walls, the sump side walls and the flanges being of integral construction.

It will be understood that the flange in this invention can take on a wide variety of shapes, sizes and locations. Its purpose is to act as an anchoring means to anchor the sump assembly when it is installed below ground. For example, the flange could take the form of a plurality of extending and depending arms extending away from the body of the sump around the opening. It is not necessary to limit the presence of a flange to the longer side walls of the sump body but there could be some form of anchoring means on the shorter sump side walls. In addition or instead of the flanges shown in FIGS. 2 to 4.

It will be appreciated that in these examples the flange has a finite and significant thickness. Thus, each flange comprises an upper and lower surface with a flange body there between. The flange body is tapered in its thickness, being wider in the region where it meets the sump body. End or side walls enclose the remaining periphery of the flange, which may be hollow, partly hollow or a solid body. Preferably the flange body where it meets the sump body is large enough to accommodate a channel which enables the sump opening to be kept substantially free of obstructions in use (see below).

The incorporation of a flange extending substantially the width of each long side wall of the sump body brings with it a further advantage. This is illustrated in FIG. 2, which shows a channel 82 set into the flange region on the inside of the sump body. This channel is designed to accommodate a so-called unistrut 83 and it is preferred that this unistrut assembly can be inserted immediately after the sump is demoulded and whilst the plastics material from which the sump is formed is still somewhat pliable. As the sump cools so it shrinks onto the unistrut and holds it in place. This is an elegant way of fixing a unistrut into the opening of a sump because it will be appreciated that it involves no holes or apertures being formed in any side wall of the sump. It also has the advantage that the unistrut is now accommodated fully or substantially fully within the side wall of the sump body or within the flange extension of the side wall of the sump body and therefore does not extend into the opening of the sump body, which remains substantially unrestricted in this regards. Whilst it is shown in FIGS. 2 to 4 inclusive that the channels 82,83 are accommodated substantially within the body of an associated flange 178,177, this is not essential. A separate groove or channel, moulded into the side wall of sump, could accommodate a unistrut channel. This would have a similar technical effect but would likely use more plastics material, and thus be more expensive to manufacture.

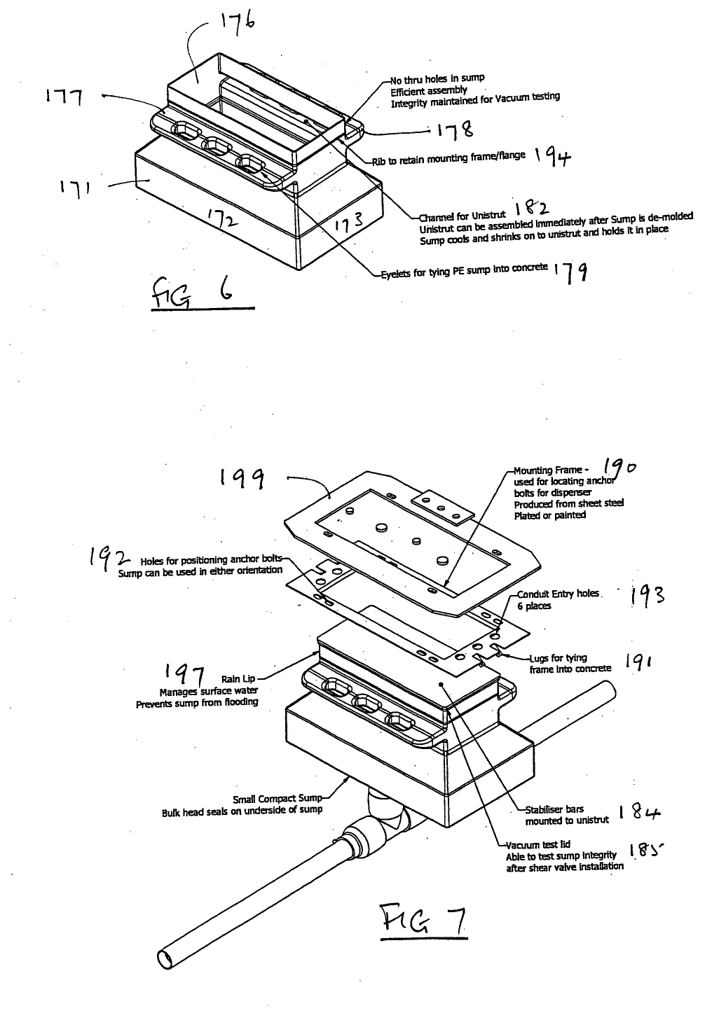

A corresponding unistrut is inserted into a corresponding channel on the opposing side face of the sump body and, in combination, they provide support along with the appropriate cross members for the pipework and other fittings, including safety fittings, for the fuel supply lines leading up to and into the fuel dispenser unit. This arrangement is shown more clearly in the cross-sectional view shown in FIG. 4.

This view emphasises how the offsetting of the channels 82 and thus the unistruts 83, away from the opening in the top of the sump, leads to a substantially clear and unrestricted opening of the sump, something which has never been possible in the past, shown in more detail in FIG. 3.

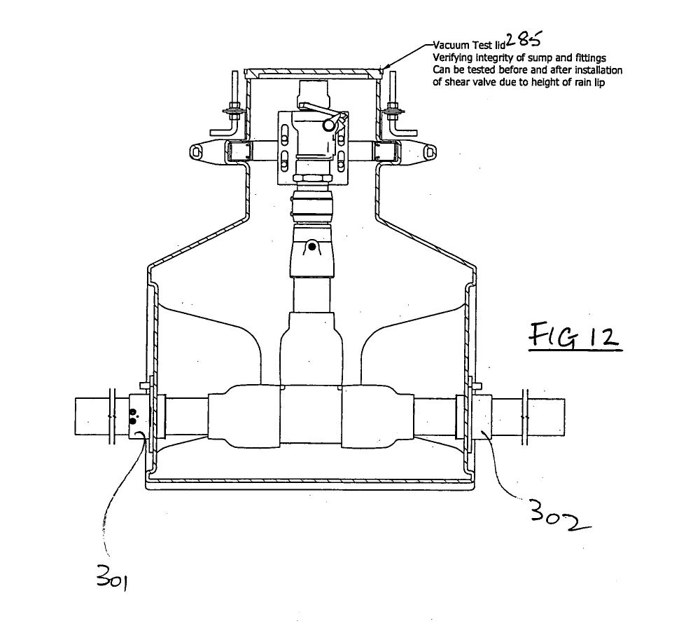

A further component of the sump assembly is a mounting frame assembly. In this embodiment the mounting frame assembly takes the form of a mounting frame 90 which is adapted and used to locate anchor bolts for the dispenser unit. Typically this mounting frame is formed from sheet steel which may be galvanised, plated or painted in order to protect it from the elements. This mounting frame incorporates a series of functional features. Firstly, it incorporates downwardly depending lugs 91 for tying the mountain frame into the surrounding concrete. In this example, four downwardly depending lugs are shown but this number could be increased or decreased as necessary. Also incorporated are conduit entry holes 93, in this example three conduit entry holes being provided at each end of the sump opening. These conduit entry points allow for the installation of conduits, and associated draw wires as necessary, in order to feed electrical and other services into the dispenser unit. Also incorporated into the mounting frame 90 are holes for positioning anchor bolts which are designed to locate into and secure the dispensing unit to the sump assembly. Four such anchoring bolts, in the form of J-bolts are shown in FIG. 10. These J-bolts are designed to extend through the fixing/anchorage means apertures in the flange and engage on the underside of the flange body, keeping the mounting frame assembly in contact with and secured to the top of the flange in use.

To further explain how the mounting frame is adapted to accommodate the base of the dispensing unit, a template for that dispensing unit base is shown as 99 in FIG. 3. It will be appreciated that sufficient holes have been provided in the mounting frame such that it can be used in either orientation, by that is meant it is not handed and could be placed over the sump opening in either of the two possible orientations providing the lugs are depending downwardly from the mounting frame.

A further feature of the current sump assembly is that a rib 94 is provided around part or substantially all of the upper section of the sump body near the opening 76 in the top of the sump. This rib is adapted to retain the mounting frame/flange in place during assembly. That is to say, the mounting frame is a tight snap fit over this rib and, once the necessary anchoring bolts have been assembled onto the mounting frame this is placed over the opening of the sump body and is tapped or otherwise forced over the rib 94. The rib extends around substantially the entire external circumference of the sump body. It is separate from the flange(s) and is located, of necessity, above the flange region. The rib is lined up, in use, with the intended ground level and the region surrounding the sump body is backfilled with concrete such that the mounting frame is level with the top of the concrete. A rain lip 97 is provided which manages any surface water which comes up to the sump body and prevents the sump from flooding.

This external snap fit is an important feature because it enables the mounting frame assembly to be attached to the sump body without making any penetrations or perforations through the sump walls. A substantially continuous rib extending around the external circumference of the sump opening is just one possible form of ‘snap fit’ arrangement. Many other forms of ‘snap fit’ arrangement are known, and may be applied in this application. For example, a series of lugs or shoulders could be formed on the outside of the sump body, adapted to engage with corresponding features on the mounting frame.

Also provided is a vacuum test lid (85) which, once held in place, means that it is possible to verify the integrity of the sump and its associated fittings by applying a vacuum to the sump assembly. This integrity can be tested both before and after installation of the sheer valves due to the height of the rain lip. That is to say, the rain lip stands sufficiently proud that it will accommodate any sheer valves installed within the sump body yet still allow the vacuum test lid to be put in place and a vacuum test to be carried out.

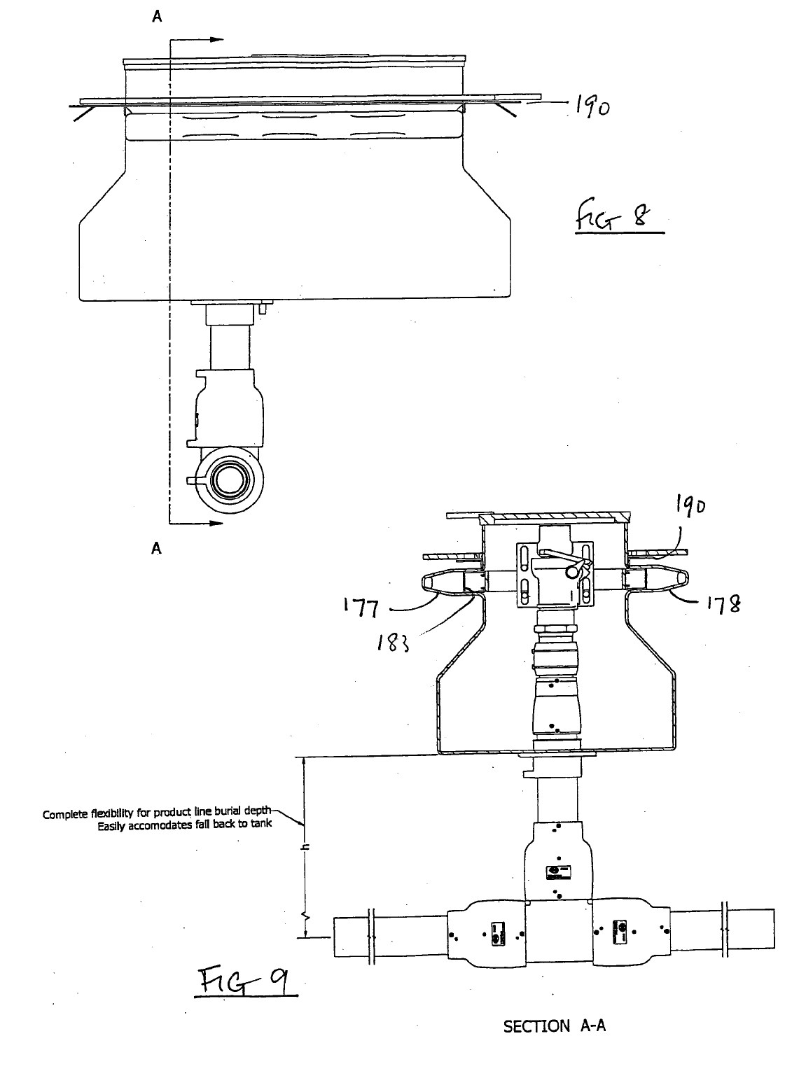

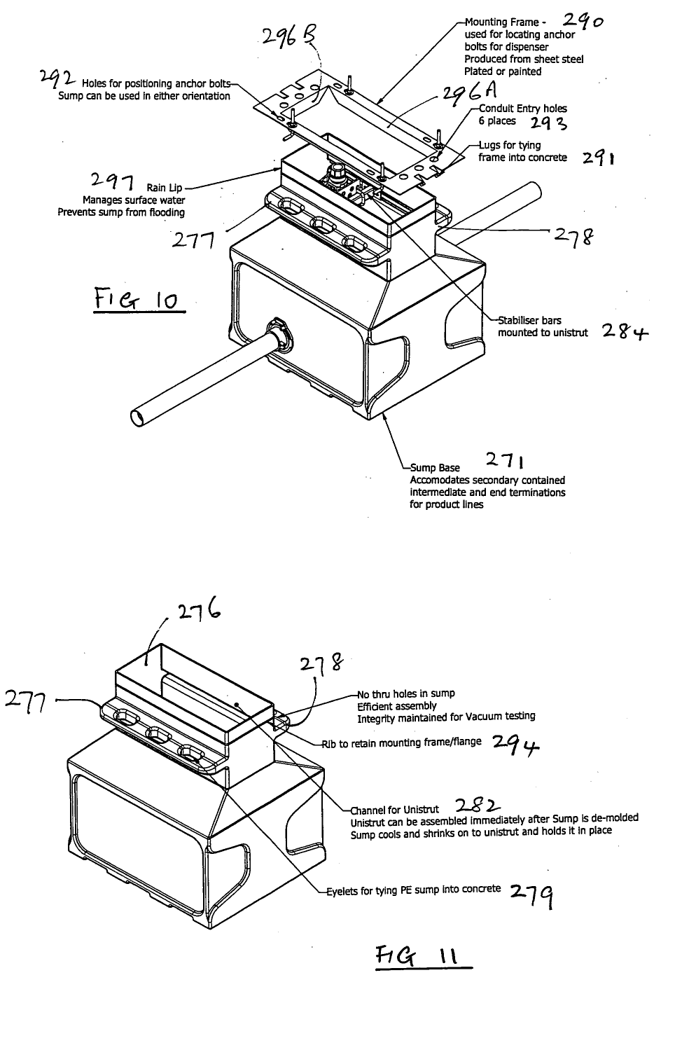

FIGS. 6 to 9 inclusive illustrate a second embodiment of the present invention, depicting a shallower sump assembly. In this embodiment, the bulkhead seals with the associated fuel supply line pipework are on the underside of the sump. Corresponding items have been given corresponding numbers to those in FIGS. 2, 3, 4 and 5.

FIGS. 10, 11 and 12 illustrate a third embodiment according to the present invention in which corresponding items have been given corresponding numbers to those in FIGS. 2, 3 and 4. In this embodiment it will be seen that the mounting frame incorporates downwardly depending regions 296A to 296D inclusive, of which only 296A and 296B are visible in FIG. 10. These downwardly depending regions add both strength and rigidity to the mounting frame and also serve to space the mounting frame away from the flanges 277 and 278 in use. Once the mounting frame has been assemble to incorporate the necessary anchoring bolts it is then forced over the retaining rib 294 and is held captive between the flanges and the retaining rib whilst allowing space for the J-bolts which extend below the mounting frame. A cross-section through the assembled and completed sump assembly is shown in FIG. 12.

It will be appreciated that all of these embodiments have in common integral flanges which incorporate fixing means adapted to tie the sump into the surrounding groundworks. They also incorporate channels, set into the body of each flange, to accommodate unistruts. These unistruts are fixed in place without the need for any penetrations through the sump walls. They also include a mounting frame assembly which again is held in place without requiring fixings which penetrate the sump walls. There are thus no gaskets or seals used in the sump which can deteriorate over time and thus no expensive maintenance is required.

The sumps are of one piece, integral construction, free from any penetrations through the sump wall(s).

The various features described above, whilst all being shown together in a single example, can be used singly in a sump, or in any desired combination. They will work independently of each other.

With regards to constructional materials, the sump body is generally formed from a plastics material such as polyethylene or polypropylene since this material is electrofusible and electrofusion couplings can be used to form a fluid-tight seal between any incoming pipework and the sump body. Such electrofusion couplings are shown in FIG. 12 as 301 and 302. The sump body could equally well be formed from glass reinforced or fibre reinforced plastic material. Typically the mounting frame assembly is formed from a metal such as steel or aluminium and is protected from the elements as necessary. Other materials may be used as selected by the materials specialist.

1-16. (canceled)

17: A sump assembly comprising:—
(i) a sump body including a bottom and at least one side wall, the bottom and side wall(s) co-operating to define an open topped internal cavity within the sump body capable of containing fluids, the side walls further defining an opening in the top of said sump;
(ii) at least one flange extending outwardly from the side wall(s), the flange incorporating an anchor adapted, in use, to tie the sump into the surrounding structure, and wherein the sump body and the flange(s) are of unitary construction, the flange(s) being formed as an integral part of the sump body such that, by providing an integral flange, it is no longer necessary to perforate the sump body in order to attach a separate frame or flanges;
(iii) a mounting frame assembly adapted, in use, to be keyed into the surrounding structure and to secure a dispensing unit in place.

18: A sump assembly as claimed in claim 17 wherein the anchor associated with the flange(s) comprises apertures or eyelets in the flange designed to be embedded in concrete.

19: A sump assembly as claimed in claim 17 wherein the flange(s) are located at or near the opening in the top of the sump.

20: A sump assembly as claimed in claim 17 wherein the flange comprises a plurality of extending and depending arms extending away from the body of the sump around the opening in the top of the sump.

21: A sump assembly as claimed in claim 17 wherein the sump body is substantially rectangular in cross-section and a flange extends substantially along the width of each long side wall of the sump body.

22: A sump assembly as claimed in claim 17 wherein the sump body further comprises a channel, said channel being adapted to accommodate a strut mounting assembly such that, when in place, said strut mounting assembly does not extend substantially into the opening in the top of the sump body and thus does not restrict access to the sump body.

23: A sump assembly as claimed in claim 22 wherein the channel is accommodated within the body of the flange, where the flange meets the sump body.

24: A sump assembly as claimed in claim 22 wherein the strut mounting assembly is held captive in the channel.

25: A sump assembly as claimed in claim 17 wherein the mounting frame assembly is a snap fit with the sump body, without the need to form penetrations in the side wall(s) of the sump.

26: A sump assembly as claimed in claim 25 wherein the sump body incorporates a retaining rib at or near the opening, said rib being adapted to retain the mounting frame assembly in a snap fit fashion without the need to form penetrations in the side wall(s).

27: A sump assembly as claimed in claim 17 wherein the mounting frame assembly comprises a mounting plate.

28: A sump assembly as claimed in claim 27 wherein said mounting plate incorporates dependent lugs adapted to tie the plate into the surrounding concrete.

29: A sump assembly as claimed in claim 27 wherein said mounting plate incorporates conduit entry holes.

30: A sump assembly as claimed in claim 27 wherein said mounting frame assembly further comprises a mounting frame adapted to secure a dispensing unit to the sump assembly, wherein said mounting frame incorporates apertures for anchor bolts to anchor a dispenser unit to the sump assembly.

31: A sump assembly as claimed in claim 17 wherein the assembly further comprises a lid, enabling the sump assembly to be vacuum tested to ensure fluid tightness before and/or after installation.

32: A sump assembly comprising:—
(i) a sump body including a bottom and at least one side wall, the bottom and side wall(s) co-operating to define an open topped internal cavity within the sump body capable of containing fluids, the side walls further defining an opening in the top of said sump;
(ii) at least one flange extending outwardly from the side wall(s), the flange incorporating an anchor adapted, in use, to tie the sump into the surrounding structure, and wherein the sump body and the flange(s) are of unitary construction, the flange(s) being formed as an integral part of the sump body such that, by providing an integral flange, it is no longer necessary to perforate the sump body in order to attach a separate frame or flanges;
(iii) a mounting frame assembly adapted, in use, to be keyed into the surrounding structure and to secure a dispensing unit in place;
wherein the sump body further comprises a channel, said channel being adapted to accommodate a strut mounting assembly such that, when in place, said strut mounting assembly does not extend substantially into the opening in the top of the sump body and thus does not restrict access to the sump body.

33: A sump assembly as claimed in claim 32 wherein the anchor associated with the flange(s) comprises apertures or eyelets in the flange designed to be embedded in concrete.

34: A sump assembly as claimed in claim 32 wherein the flange(s) are located at or near the opening in the top of the sump.

35: A sump assembly as claimed in claim 32 wherein the flange comprises a plurality of extending and depending arms extending away from the body of the sump around the opening in the top of the sump.

36: A sump assembly as claimed in claim 32 wherein the sump body is substantially rectangular in cross-section and a flange extends substantially along the width of each long side wall of the sump body.

37: A sump assembly as claimed in claim 32 wherein the channel is accommodated within the body of the flange, where the flange meets the sump body.

38: A sump assembly as claimed in claim 32 wherein the strut mounting assembly is held captive in the channel.

39: A sump assembly as claimed in claim 32 wherein the mounting frame assembly is a snap fit with the sump body, without the need to form penetrations in the side wall(s) of the sump.

40: A sump assembly as claimed in claim 39 wherein the sump body incorporates a retaining rib at or near the opening, said rib being adapted to retain the mounting frame assembly in a snap fit fashion without the need to form penetrations in the side wall(s).

41: A sump assembly as claimed in claim 32 wherein the mounting frame assembly comprises a mounting plate.

42: A sump assembly as claimed in claim 41 wherein said mounting plate incorporates dependent lugs adapted to tie the plate into the surrounding concrete.

43: A sump assembly as claimed in claim 41 wherein said mounting plate incorporates conduit entry holes.

44: A sump assembly as claimed in claim 41 wherein said mounting frame assembly further comprises a mounting frame adapted to secure a dispensing unit to the sump assembly, wherein said mounting frame incorporates apertures for anchor bolts to anchor a dispenser unit to the sump assembly.

45: A sump assembly as claimed in claim 32 wherein the assembly further comprises a lid, enabling the sump assembly to be vacuum tested to ensure fluid tightness before and/or after installation.

46: A sump assembly comprising:—
(i) a sump body including a bottom and at least one side wall, the bottom and side wall(s) co-operating to define an open topped internal cavity within the sump body capable of containing fluids, the side walls further defining an opening in the top of said sump;
(ii) at least one flange extending outwardly from the side wall(s), the flange incorporating an anchor adapted, in use, to tie the sump into the surrounding structure, and wherein the sump body further comprises a channel, said channel being adapted to accommodate a strut mounting assembly such that, when in place, said strut mounting assembly does not extend substantially into the opening in the top of the sump body and thus does not restrict access to the sump body;
(iii) a mounting frame assembly adapted, in use, to be keyed into the surrounding structure and to secure a dispensing unit in place.

47: A sump assembly as claimed in claim 46 wherein the anchor associated with the flange(s) comprises apertures or eyelets in the flange designed to be embedded in concrete.

48: A sump assembly as claimed in claim 46 wherein the flange(s) are located at or near the opening in the top of the sump.

49: A sump assembly as claimed in claim 46 wherein the flange comprises a plurality of extending and depending arms extending away from the body of the sump around the opening in the top of the sump.

50: A sump assembly as claimed in claim 46 wherein the sump body is substantially rectangular in cross-section and a flange extends substantially along the width of each long side wall of the sump body.

51: A sump assembly as claimed in claim 46 wherein the channel is accommodated within the body of the flange, where the flange meets the sump body.

52: A sump assembly as claimed in claim 46 wherein the strut mounting assembly is held captive in the channel.

53: A sump assembly as claimed in claim 46 wherein the mounting frame assembly is a snap fit with the sump body, without the need to form penetrations in the side wall(s) of the sump.

54: A sump assembly as claimed in claim 53 wherein the sump body incorporates a retaining rib at or near the opening, said rib being adapted to retain the mounting frame assembly in a snap fit fashion without the need to form penetrations in the side wall(s).

55: A sump assembly as claimed in claim 46 wherein the mounting frame assembly comprises a mounting plate.

56: A sump assembly as claimed in claim 55 wherein said mounting plate incorporates dependent lugs adapted to tie the plate into the surrounding concrete.

57: A sump assembly as claimed in claim 55 wherein said mounting plate incorporates conduit entry holes.

58: A sump assembly as claimed in claim 55 wherein said mounting frame assembly further comprises a mounting frame adapted to secure a dispensing unit to the sump assembly, wherein said mounting frame incorporates apertures for anchor bolts to anchor a dispenser unit to the sump assembly.

59: A sump assembly as claimed in claim 55 wherein the assembly further comprises a lid, enabling the sump assembly to be vacuum tested to ensure fluid tightness before and/or after installation.
